(19) United States
(12) Patent Application Publication
(10) Pub. No.: US 2013/0322674 A1
(43) Pub. Date: Dec. 5, 2013

(54) METHOD AND SYSTEM FOR DIRECTING SOUND TO A SELECT USER WITHIN A PREMISES

(71) Applicants: Dahai Ren, Lincoln, MA (US); Ming Chen, Bedford, MA (US)

(72) Inventors: Dahai Ren, Lincoln, MA (US); Ming Chen, Bedford, MA (US)

(73) Assignee: Verizon Patent and Licensing Inc., Basking Ridge, NJ (US)

(21) Appl. No.: 13/485,134

(22) Filed: May 31, 2012

(51) Int. Cl. H04R 1/20

(52) U.S. Cl. 381/337

(57) ABSTRACT

An approach for enabling audio content to be directed to a select user from any location within a premises is described. A directional sound module determines a signal strength of a mobile device associated with a user relative to a wireless access point located within a premises and correlates the signal strength to a reference location within the premises based on predetermined wireless fingerprint information. The directional sound module then determines a direction to transmit an ultrasound signal for conveying audible sound to the user.

### BACKGROUND INFORMATION

Service providers are continually challenged to deliver value and convenience to consumers by providing compelling network services and advancing the underlying technologies. One area of particular interest is providing services for enhancing the user content delivery and enjoyment experience. Traditional loudspeaker systems emit wide spreading audio signals that may be heard by anyone within range of the speakers. Consequently, a user is limited in their ability to listen to television or radio content while in the presence of others located in the same premises without disturbing them. Furthermore, there is no convenient means of enabling content to be directed to a specific user as they move about the premises.

Based on the foregoing, there is a need for enabling audio content to be directed to a select user from any location within a premises.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system for enabling audio content to be directed to a select user from any location within a premises, according to one embodiment;

FIG. 2 is a diagram of the components of a directional sound system, according to one embodiment;

FIGS. 3A-3D are flowcharts of processes for enabling audio content to be directed to a select user from any location within a premises, according to various embodiments;

FIGS. 4A-4D are diagrams of a user of a mobile device receiving audio content from various locations within a premises, according to various embodiments;

FIG. 5 is a diagram of a computer system that can be used to implement various exemplary embodiments; and

FIG. 6 is a diagram of a chip set that can be used to implement an embodiment of the invention.

### DESCRIPTION OF THE PREFERRED EMBODIMENT

An apparatus, method and software for enabling audio content to be directed to a select user from any location within a premises are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form to avoid unnecessarily obscuring the present invention.

Although the various exemplary embodiments are described with respect to wireless fingerprinting, it is contemplated that these embodiments have applicability to any type of wireless device identification or tracking techniques. This may include, for example, various location based tracking techniques, short range communications techniques and the like.

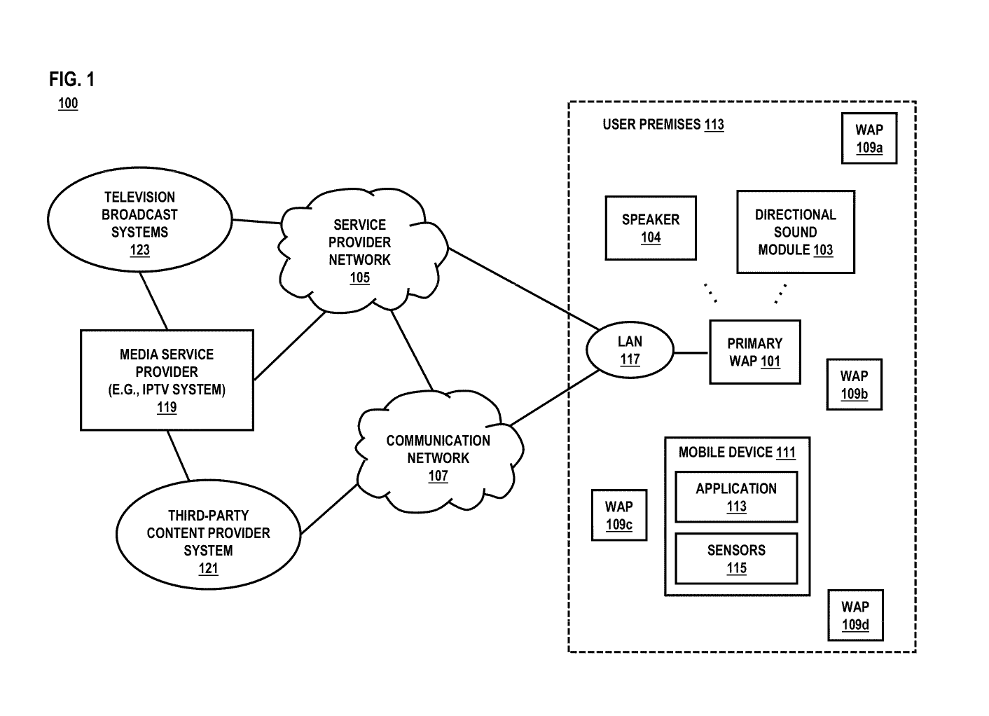

FIG. 1 is a diagram of a system for enabling audio content to be directed to a select user from any location within a premises, according to one embodiment. As noted previously, many devices capable of rendering audio content (e.g., stereos, televisions, computers, home entertainment systems) feature loudspeakers that cast sound in multiple directions. Consequently, any person within range of the loudspeakers is able to hear the sound, which can be a disturbance to those not interested in listening. For instance, in the case where multiple people are located in the same area of a premises (e.g., house, building) where the loudspeakers are featured, there is currently no convenient approach for directing the sound to a specific user (or area) while excluding the others. Furthermore, there is currently no convenient means of providing targeted sound to the user as they move about the premises.

To address this issue, a directional sound module 103 of system 100 is configured to trigger the transmission of modulated ultrasound signals to a mobile device 111 user based on their relative location within a premises 113. Such tracking of the mobile device 111 for targeted sound transmission may be performed dynamically as the user moves about the premises 113. By way of example, the modulated ultrasound signal may be transmitted via an ultrasound speaker 104 that interfaces with a primary wireless access point (WAP) 101. Under this scenario, the primary WAP 101 may include any device capable of accessing a local area network (LAN) 117 of the premises 113 for facilitating data exchange and communication via a network (e.g., service provider network 105). LAN 117 may utilize the dynamic host configuration protocol (DHCP) to dynamically assign “private” DHCP internet protocol (IP) addresses to the primary WAP 101, the wireless access points 109 and the directional sound module 103, i.e., IP addresses that are accessible to device 111. According to certain embodiments, routers (not shown) may be used for establishing and operating, or at least connecting to the LAN 117.

For the purpose of illustration, the primary WAP 101 may include a set-top box, stereo system, computer or any other network ready device. Also, the directional sound module 103 may be integrated within the primary WAP 101 (e.g., as one or more components). Alternatively, the directional sound module 103 may itself be implemented as a connectable component of the primary WAP 101 for enabling various targeted sound guidance and tracking capabilities. For example, in the case of the primary WAP being a stereo system, the directional sound module 103 may be integrated within the stereo or added as a peripheral component via interface/connectivity means. The exemplary embodiments presented herein contemplate various implementations.

In certain embodiments, the primary WAP 101 may interact with various other WAPs 109a-109d located at different places within the premises 113. While not shown expressly in FIG. 1, the different WAPs 109a-109d (referred to collectively as WAPs 109) may also be configured to the LAN 117. It is noted that the LAN 117 of the premises 113 may include both wired and wireless configurations and network topologies (e.g., wireless local area network) for facilitating communication between any network ready devices within the premises 113. This includes, for example, various mobile devices 111 of a user. The directional sound module 103 may be accessed by the primary WAP 101, the mobile device 111 or the other WAPs 109.

In certain embodiments, the directional sound module 103 employs various wireless device identification and/or tracking techniques, such as wireless fingerprinting, to determine (e.g., dynamically) the relative position and/or location of the user within the premises 113. In addition, the directional sound module 103 initiates, via the primary wireless access point 101, transmission of a modulated ultrasonic signal based on the determined position and/or location of the user. In certain embodiments, the system 100 employs wireless fingerprinting and ultrasound audio transmission to enhance the user listening experience.

Wireless fingerprinting may include, for example, any technique by which the module 103 is able to differentiate between the unique wireless devices configured to operate over the LAN 117. For the purpose of illustration, the directional sound module 103 employs signal strength based wireless fingerprinting, wherein the specific identity and relative geolocation of a given mobile device within the premises 113 is determined based on the signal strength between the device 111, the primary WAP 101 and/or the various WAPs 109. It is noted, however, that various other wireless fingerprinting techniques, including radio fingerprinting, time and direction of arrival approximation, signal triangulation, various modeling approaches and the like may be employed. Furthermore, these techniques may be employed in conjunction with various location based services, short range communication protocols and geolocation techniques for indoor identification and/or tracking.

In certain embodiments, per wireless fingerprinting, the directional sound module 103 maintains wireless fingerprint information as collected during a training and/or registration process between the mobile device 111 and the module 103. The wireless fingerprint information (not shown) is used for determining a mapping between determined signal strengths, at a specific location within the premises 113, for a specific mobile device 111 relative to WAPs 109 or primary WAP 101. In addition, the wireless fingerprint information may correspond to a set of data for uniquely identifying the mobile device 111 with various signal strengths at respective different coordinate positions within the premises. Consequently, the wireless fingerprint information for a mobile device 111 is relevant for a given deployment/position of the wireless access points about the premises 113. It is noted that the wireless fingerprint information may include, for example, data for indicating a signal strength value at a location within the premises, for a specific named wireless access point and/or mobile device.

For the purpose of illustration, the training process for gathering of the wireless fingerprint information may be performed at the discretion of the user of the mobile device 111. The training may correspond to an initial installation of the wireless access point and/or the directional sound module 103 within the premises 113. Still further, the training may be performed in response to the moving, removal or deactivation of a wireless access point. It is noted the relevance and accuracy of the wireless fingerprint information may be impacted by various factors. This includes, for example, the frequency of performance of training, the number of wireless access points, the deployment of the wireless access points about the premises 113, the size, dimensions and material composition of the premises 113, the geometrical relation among the positions of the mobile device 111 and the wireless access points, the effectiveness of any noise/error correction filtering techniques (e.g., Kalman filter or particle filter) applied to the wireless fingerprint information, etc. By way of example, the training procedure is described in Table 1 below:

TABLE 1
Each wireless access point (including the primary 101) is assigned a pair
of X and Ycoordinates for representing its location within the premises
113. Also, one of the wireless access points is specified as the
primary—i.e., the wireless access point having access to the
directional sound module 103.
The floor plan of the premises, especially the area where the ultrasound
speaker 104 is placed, is scanned (e.g., coordinates determined and
corresponding signal strengths stored). For instance, the user walks around
the building via the mobile device 111 and records signal strengths of the
wireless access points at various reference positions.
The collected data is stored into a wireless fingerprint information
database.

It is noted that an application 113 of the mobile device 111 may be configured to retrieve the wireless fingerprint information (e.g., via sensors 115) from the directional sound module 103 as well as facilitate the training procedure. Also, the directional sound module 103 facilitates the data collection process via the primary WAP 101, i.e., triggering the primary WAP 101 to transmit and/or receive signal strength data for the mobile device 111 and/or other wireless access points 109.

Once the training procedure is completed (e.g., the wireless fingerprint information database is compiled), the ° directional sound module 103 is able to use the data to predict/deduce/determine the location of the mobile device 111 within the premises 113. This deduction is made based on the analysis of the collected wireless fingerprint information against current signal strength data, processing of the wireless fingerprint information according to various fingerprinting techniques, or a combination thereof. Table 2 below outlines an exemplary location determination procedure performed by the module 103. It is noted that this procedure may be triggered for persistent execution by the directional sound module 103, in conjunction with the primary WAP 101. This enables the module 103 to account for adaptations in the location of the user, i.e., as they move about the premises 113.

TABLE 2
The primary WAP 111 collects signal strengths sensed by it and sensed
by WAPs 109.
The primary WAP 111 searches the wireless fingerprint information
database and processes the wireless fingerprint information based
on different wireless fingerprinting techniques and schemes, i.e.,
k-closest neighbor fingerprinting or probabilistic estimation.

It is noted that in addition to processing the wireless fingerprint information per a specific algorithm, various data correlation factors may also be employed against the wireless fingerprint information. This includes, for example, evaluating the data based on similarity threshold criteria (e.g., does the signal strength and/or position match to at least Y percentage), the recentness of the wireless fingerprint information (e.g., is the wireless fingerprint information current to within at least X number of days), etc.

The k-closest neighbor fingerprinting and probabilistic estimation schemes/algorithms are presented in the foregoing paragraphs. In addition to these algorithms, various data filtering and correction techniques may be employed for refining the location determination results.

k-Closest Neighbor Fingerprinting Scheme

The module 103 goes through the wireless fingerprint information database and picks k referenced positions that best match the observed received signal strength tuple (e.g., an ordered list of elements). The criterion commonly retained is the Euclidian distance (in signal space) metric. If Z=[RSS₁, . . . , RSS_{M}] is the observed (received signal strength) RSS vector composed of M received access points at the unknown position X=(x, y) and Zᵢ the footprint recorded in the database for the position Xi=(xᵢ, yᵢ), then this Euclidian distance is

$$d ( Z , {Z}_{i} ) = \frac{1}{M} \cdot \sqrt{{\sum }_{j = 1}^{M} {( {RSS}_{j} ( x , y ) - {RSS}_{j} ( {x}_{i} , {y}_{i} ) )}^{2}} , \qquad ( 3 )$$

where RSSⱼ [xᵢ, yᵢ] is the mean value recorded in the wireless fingerprint information database for the access point whose media access control (MAC) address is noted “j” at the position (xᵢ, yᵢ).

The set Nₖ of the database positions having the smallest errors is built with an iterative process as follows:

$${N}_{k} = \{ {argmin}_{{X}_{t} ∈ ℒ} [ d ( Z , {Z}_{i} ) ] \backslash {X}_{i} ∉ {N}_{k - 1} \} , \qquad ( 4 )$$

where L is the set of positions recorded in the wireless fingerprint information database. This set contains k positions. Finally, the position of the mobile device 111 is considered to be the barycenter of those k selected positions:

$$X = \frac{{\sum }_{j = 1}^{k} ( 1 / d ( Z , {Z}_{i} ) ) \cdot {X}_{j}}{{\sum }_{j = 1}^{k} ( 1 / d ( Z , {Z}_{i} ) )} with {X}_{j} ∈ {N}_{k} . \qquad ( 5 )$$

### Probabilistic Estimation Scheme

This wireless fingerprinting approach is based on an empirical model that describes the distribution of received signal strengths at various locations. The use of probabilistic models provides a natural way to handle uncertainty and errors in signal power measurements. Thus, after the calibration phase, for any given location X, a probability distribution Pr [Z|X] assigns a probability for each measured signal vector Z. Applying the Bayes rule leads to the following posterior distribution of the location:

$$\begin{matrix}Pr [ X \vert Z ] = \frac{Pr [ Z \vert X ] \cdot Pr [ X ]}{Pr [ Z ]} \\ = \frac{Pr [ Z \vert X ] \cdot Pr [ X ]}{{\sum }_{{X}_{t} ∈ ℒ} Pr [ Z \vert {X}_{i} ] \cdot Pr [ {X}_{i} ]} ,\end{matrix} \qquad ( 6 )$$

where Pr [X] is the prior probability of being at location/before knowing the value of the observation variable, and the summation goes over the set of possible location values, denoted by L.

The prior distribution Pr [X] gives a simple way to incorporate background information, such as personal user profiles, and to implement tracking. In case neither user profiles nor a history of measured signal properties allowing tracking are available, one can simply use a uniform prior which introduces no bias towards any particular location. As the denominator Pr [Z] does not depend on the location variable l, it can be treated as a normalizing constant whenever only relative probabilities or probability ratios are required.

The posterior distribution Pr [X|Z] can be used to choose an optimal estimator of the location based on whatever loss function is considered to express the desired behavior. For instance, the squared error penalizes large errors more than small ones. If the squared error is used, the estimator minimizing the expected loss is the expected value of the location variable:

$$E [ X \vert Z ] = {\sum }_{{X}_{t} ∈ ℒ} l \cdot Pr [ X \vert Z ] \qquad ( 7 )$$

assuming that the expectation of the location variable is well defined, that is, the location variable is numerical. Location estimates, such as the expectation, are more useful if they are complemented with some indication about their precision.

In certain embodiments, the directional sound module 103 causes the primary WAP 101 to initiate transmission of a beam of ultrasound in the determined direction of the mobile device 111. The primary WAP 101 interfaces with an ultrasound speaker system 104, which generates the ultrasonic beam. Hence, the ultrasound speaker system 104 transmits audio content at an ultrasonic frequency (e.g., approximately 20 kHz or greater). It is noted that ultrasound waves have much shorter wave length than traditional audio signals. The frequency of the ultrasound decays on its path from the speaker system 104 to the mobile device 111 due to the collision of the sound with air particles. The sound eventually becomes audible when it reaches the mobile device 111 at its determined location.

In certain embodiments, the directional sound module 103 recalculates the position of the mobile device 111 based on one or more of the above described signal strength based wireless fingerprinting approaches. Under this scenario, as the user moves about the premises 113 with their mobile device 111, the directional sound module 103 causes the primary WAP 101 to redirect the ultrasound beam to the updated location of the user via the ultrasound speaker. While various implementations exist, the ultrasound speaker 104 may include a combination of an ultrasound sound transmitter and traditional loudspeaker. Also, of note, the ultrasound beam may be conveyed to the user (as audible sound) with or without the use of a receiver set (e.g., headset or dedicated demodulator). In the case of the latter, for instance, the audio signal may be perceived by the user when the modulated ultrasound signal as directed passes through air within a relative/predetermined range of the user or anything which behaves nonlinearly and thus acts intentionally or unintentionally as a demodulator. Hence, the user only need be within range of the guided ultrasound beam; such that others out of range are unable to perceive the audio transmission.

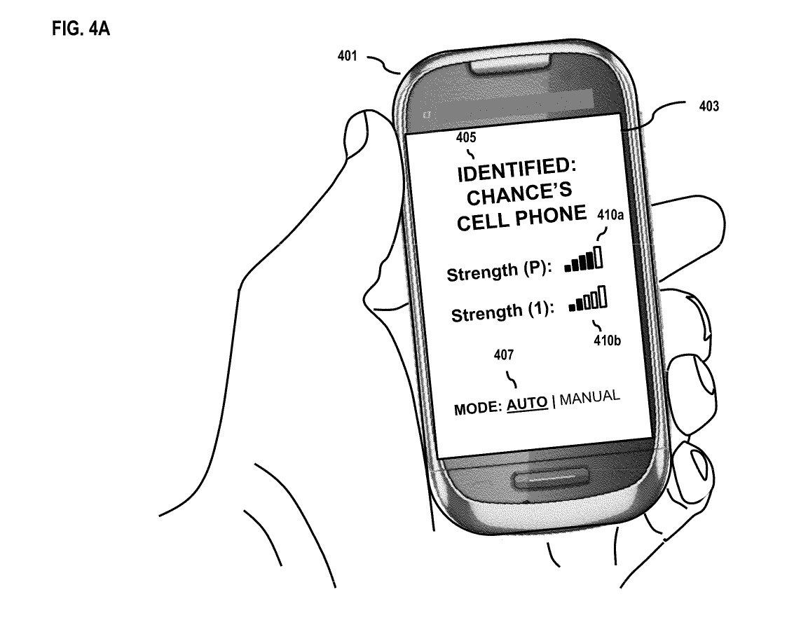

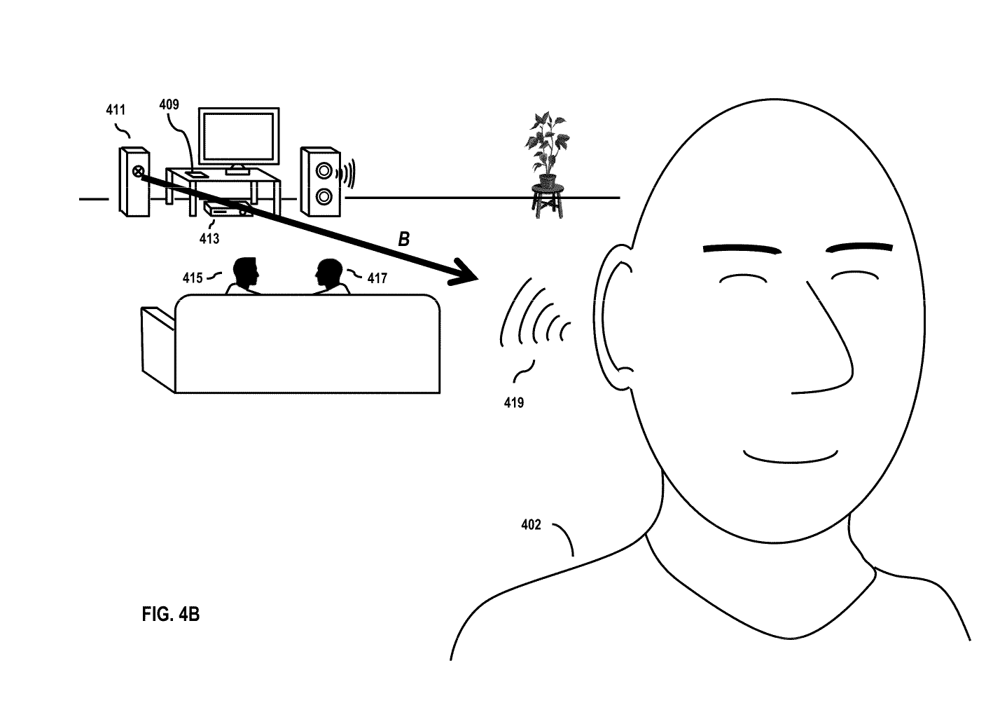

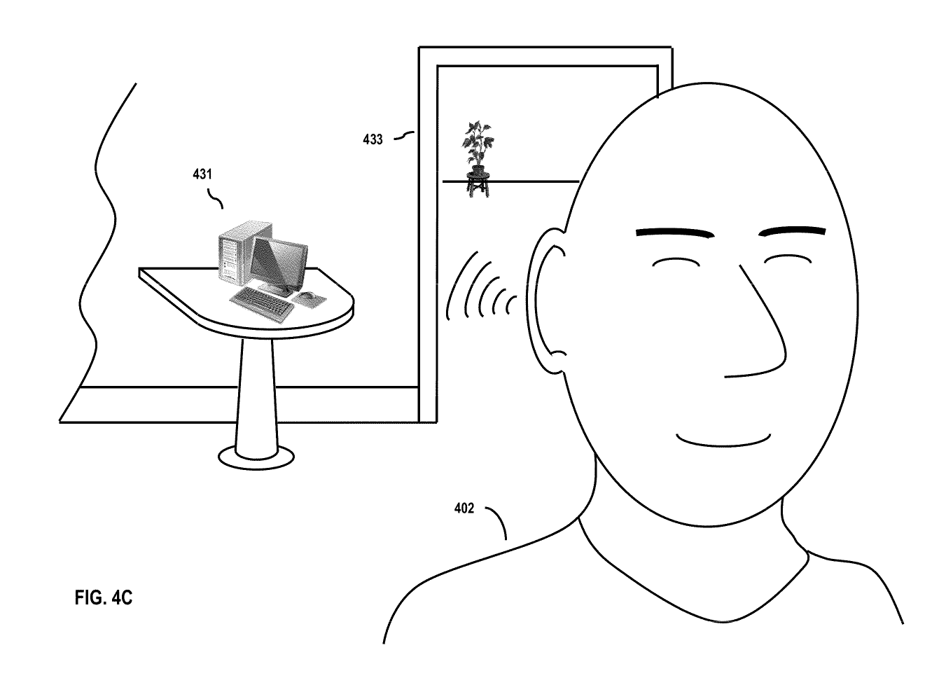

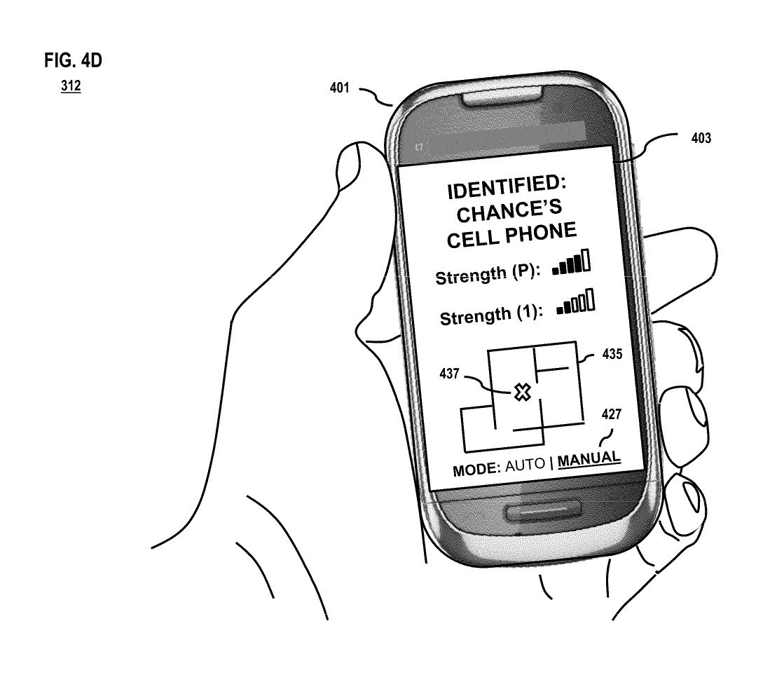

It is contemplated, in certain embodiments, that an alternative approach for determining the relative location of the user may be employed. For example, the mobile device 111 may sense the signal strengths from all the wireless access points from a relative position within the premises via sensors 115. Based on the determined signal strengths, the directional sound module 103 calculates the position of the mobile device 111 and then orders the ultrasound speaker system 104 of the primary WAP 101 to transmit an ultrasound beam in the exact direction of the user. As will be discussed more fully later on with respect to FIG. 4D, the user may specify the location to direct the transmission to by way of a visual depiction of the premises (e.g., a floor plan). This may be enabled via a user interface generated by the application 114 at the mobile device 111.

The mobile device 111 may be any type of mobile terminal, fixed terminal or portable terminal including a mobile handset, station, unit, device, multimedia computer, multimedia tablet, Internet node, communicator, desktop computer, laptop computer, Personal Digital Assistants (PDAs), smartphone or any combination thereof. It is also contemplated the mobile device 111 can support any type of interface for supporting the presentment or exchange of data. In addition, user device 111 may facilitate various input means for receiving and generating information, including touch screen capability, keyboard and keypad data entry, voice-based input mechanisms and the like. Any known and future implementations of devices 111 are applicable.

By way of example, the primary WAP 101 and corresponding directional sound module 103 may be configured to communicate using one or more of networks 105 and 107. System 107 can include: a public data network (e.g., the Internet), various intranets, local area networks (LAN), wide area networks (WAN), the public switched telephony network (PSTN), integrated services digital networks (ISDN), other private packet switched networks or telephony networks, as well as any additional equivalent system or combination thereof. These networks may employ various access technologies including cable networks, satellite networks, subscriber television networks, digital subscriber line (DSL) networks, optical fiber networks, hybrid fiber-coax networks, worldwide interoperability for microwave access (WiMAX) networks, wireless fidelity (WiFi) networks, other wireless networks (e.g., 3G or 4G wireless broadband networks, mobile television networks, radio networks, etc.), terrestrial broadcasting networks, provider specific networks (e.g., fiber optic networks, cable networks, etc), and the like. Such networks may also utilize any suitable protocol supportive of data communications, e.g., transmission control protocol (TCP), internet protocol (IP), file transfer protocol (FTP), telnet, hypertext transfer protocol (HTTP), hypertext transfer protocol secure (HTTPS), asynchronous transfer mode (ATM), socket connections, Ethernet, frame relay, and the like, to connect content processing devices 103 to various sources of media content, such as one or more third-party content provider systems 121. Although depicted in FIG. 1 as separate networks, communication network 107 may be completely or partially contained within service provider network 105. For example, service provider network 105 may include facilities to provide for transport of packet-based communications, including audio data.

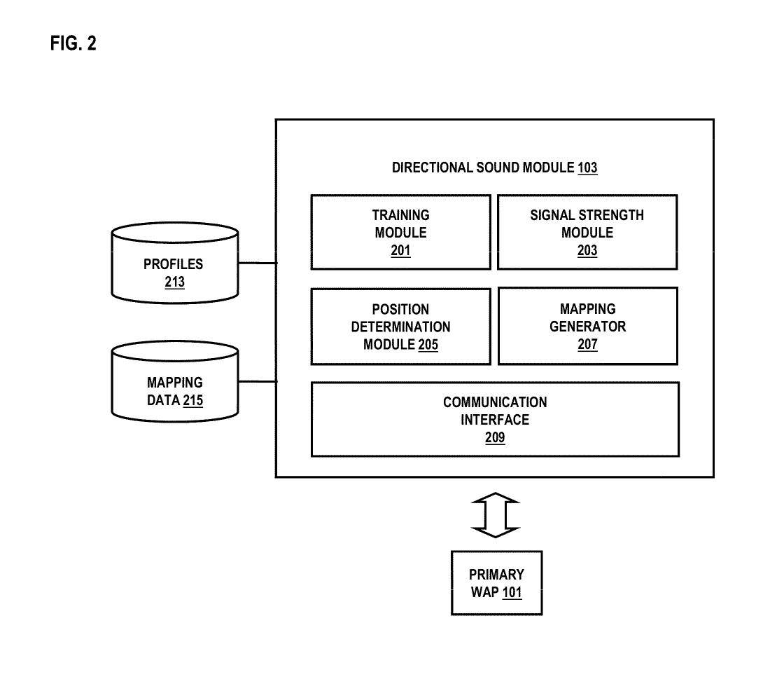

FIG. 2 is a diagram of the components of a directional sound module, according to one embodiment. The directional sound module 103 includes various executable modules for performing one or more computing, data processing and network based instructions that in combination provide a means of enabling audio content to be directed to a select user from any location within a premises. Such modules can be implemented in hardware, firmware, software, or a combination thereof. By way of example, the directional sound module 103 may include a training module 201, a signal strength module 203, a position determination 205, a mapping generator 207 and a communication interface 209.

In addition, the directional sound module 103 also maintains various databases (e.g., databases 213 and 215) for storing wireless fingerprint information as generated per the training procedure for a given mobile device and profile information pertaining to the device user. It is noted that modules 201-209 access several of these databases for performing their respective functions.

In one embodiment, a training module 201 facilitates the training procedure for the mobile device 111. By way of example, the training module 201 receives a request for activation of the training procedure from the mobile device 111 of a user. The module 201 then collects signal strength data as determined for the mobile device 111 relative to the various other wireless access points within the premises 113. This includes, for example, the collecting of signal strength data at various different locations of the premises relative to each of the different wireless access points including the primary. As the data is collected, the training module 201 passes the data to the mapping generator 207, which compiles and organizes the wireless fingerprint information database 215. It is noted that the training module 201 may also be configured to define an established time period and frequency of collection of the various signal strengths.

In addition to the above, the training module 201 registers users and user devices 101a (e.g., a mobile device) for interaction with the directional sound module 103. By way of example, the training module 201 receives a request to enable directional sound capabilities for a user and a given device relative to the premises and the data collected during training. For example, the subscription process may include the inputting of data for defining the dimensions, floor plan and other characteristics of the premises 113. Still further, various users permissions and settings criteria may be established for a specific user, including preferred sound settings, audio modes (e.g., Acoustic mode versus Hip-Hop mode), etc. Preferences and settings information may be referenced as profile information 215, thus establishing a correlation between a specific user and a specific set of wireless fingerprint information 215.

The registration process performed by the module 201 may also include receiving and validating a login name and/or user identification value as provided or established for a particular user during a subscription/registration process. The login process may also be performed in response to an access attempt or exchange between a user device 101 and a desired resource 121. In certain embodiments, the access attempt is facilitated by the detection module 214, and is triggered in response to a proximity condition being met between the user device 101 and the resource 121 (e.g., via a wireless link). The login name and/or user identifier value may be received as input provided by the user from the user device 101 or other device via a graphical user interface to the directional sound module 103 (e.g., as enabled by a user interface module). It is noted that the profile information 213 may also include information for identifying the device and/or a network configuration associated with the device, including an IP address, a carrier detection signal, mobile directory number (MDN), subscriber identity module (SIM) (e.g., of a SIM card), radio frequency identifier (RFID) tag or other identifier associated therewith. Hence, this information 213 may automatically be cross referenced as part of an activation and/or login process in response to the determined presence of a registered mobile device within the premises.

In one embodiment, the mapping generator 207 organizes the data collected during the training procedure such that the signal strength is correlated with a specific coordinate position within the premises 113. By way of this approach, the mapping generator 207 facilitates subsequent retrieval of position information in response to a detected signal strength occurring after the training period.

In one embodiment, the signal strength module 203 operates in connection with the training module 201 for determining signal strengths of the mobile device relative to the various other access points. As noted, the various sensors 115 of the mobile device may detect signal strength information as the user moves about the premises and comes within range of a given wireless access point. Consequently, the signal strength module 203 queries the various mobile devices within the premises as well as the wireless access points for the collected data. It then passes the data to the mapping generator 207 and/or training module 201 accordingly. By way of the signal strength module 203, the signal strength from the mobile devices within the premises (e.g., those configured to actively share signal information) can be sensed by the various wireless access points deployed throughout the premises 113.

In one embodiment, the position determination module 205 determines the position within the premises corresponding to particular signal strength information detected for a mobile device. By way of example, the position determination module 205 is triggered for execution subsequent to the training process, i.e., per subsequent interaction of a given mobile device with the primary WAP 101 and the various wireless access points 109a-109d. The position determination module 205 queries the wireless fingerprint information database 215 and processes said data 215 according to various wireless fingerprinting algorithms/schemes (e.g., k-Closest Neighbor Fingerprinting). In addition, the position determination module 205 may employ various modeling and data filtering techniques for enhancing the accuracy of correlation of a given signal strength with a position in the premises, including for example, signal propagation modeling, empirical signal propagation modeling, linear regression analysis, multiple regression analysis, simulation experimentation and the like.

It is noted that the position determination module 205 enables a fine tuned position determination result to be calculated per the signal based wireless fingerprinting approach. Various factors may affect the location determination error of the mobile device within the premises 113, including for example, the type and effectiveness of filtering/modeling techniques employed, the number and placements of wireless access points about the premises 113 and the geometrical relation among the positions of the mobile devices and wireless access points. In certain embodiments, the primary WAP 101 may be or at least correspond to the location of an audio device, such as a home entertainment system within the living room of a user's home.

Once a position is determined, the position determination module 205 further determines a direction of the mobile device relative to the primary WAP 101. For example, the direction may be calculated as a directional vector based on the determined current position information. This direction information is then passed on to a communication interface 209. Of note, the position determination module 205 consistently performs this operation in response to updated signal strength information for a given mobile device 111, i.e., as the user moves about the premises 113.

In one embodiment, a communication interface 209 facilitates generation of a signal for triggering execution of an ultrasound speaker 104. The ultrasound speaker casts a beam of ultrasound in the direction of the mobile device 111 as determined. In addition, the communication interface 209 enables formation of a session over the LAN 117 between the directional sound module 103, the mobile device(s) 111 and the various other wireless access points 109. By way of example, the communication interface 209 executes various protocols and data sharing techniques for enabling collaborative data exchange. For example, the signal strengths and the indoor geo locations of the wireless access points 109 may be transferred to the primary wireless access point 101 for facilitating calculation of the indoor location of the mobile device per the position determination module 205.

The above presented modules 201-209 of the directional sound module 103 can be implemented in hardware, firmware, software, or a combination thereof. Though depicted as component capable of interfacing with or being directly implemented within a primary WAP 101, it is contemplated the directional sound module 103 may be implemented as a platform, hosted solution, cloud based service, or the like. Furthermore, it is noted that the various modules 201-209 may be used selectively or in combination within the context of a local area networking scheme.

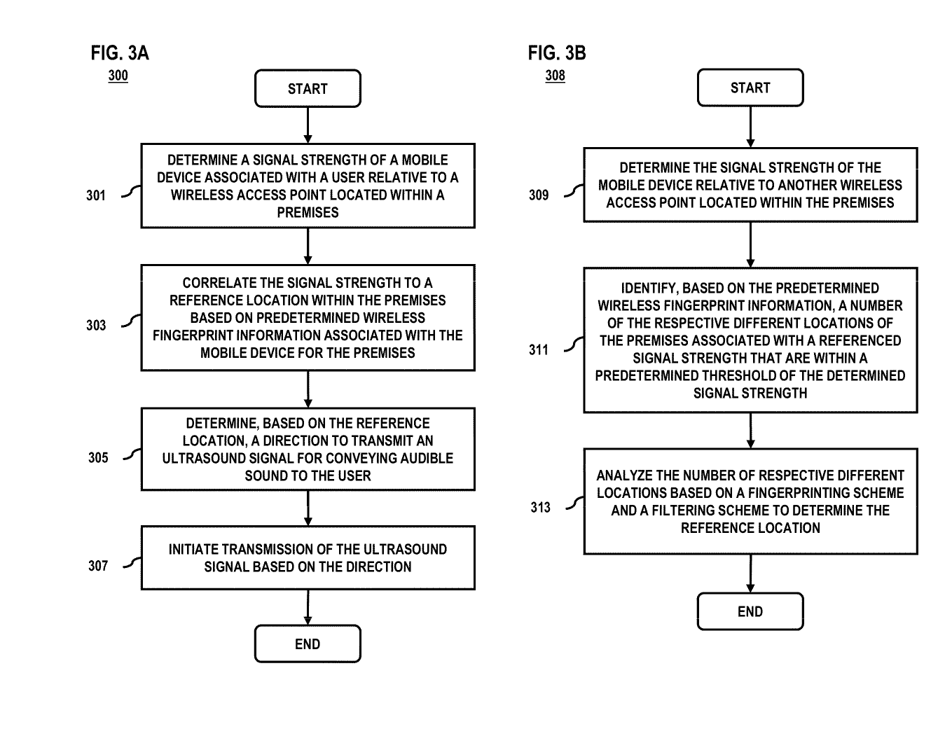

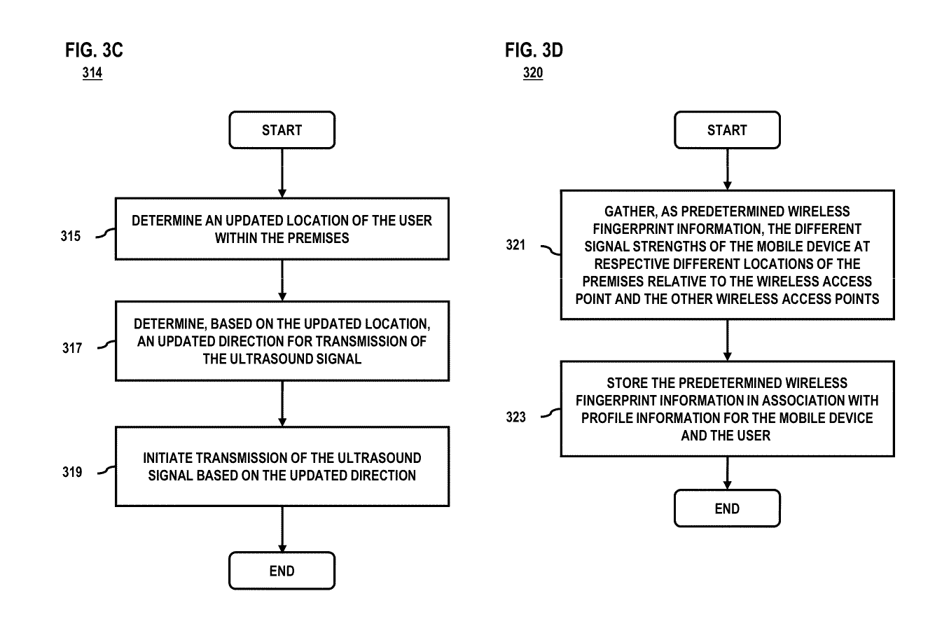

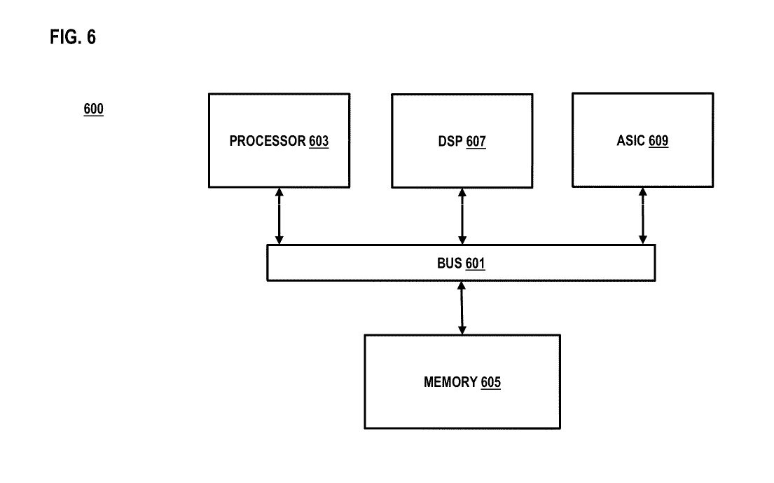

FIGS. 3A-3D are flowcharts of processes for enabling audio content to be directed to a select user from any location within a premises, according to various embodiments. In one embodiment, the directional sound module 103 performs processes 300, 308, 314 and 320 are implemented in, for instance, a chip set including a processor and a memory as shown in FIG. 6. For the purpose of illustration, the processes are described with respect to FIG. 1. It is noted that the steps of the process may be performed in any suitable order, as well as combined or separated in any suitable manner.

Process 300 (FIG. 3A) involves the directional sound module 103 determining, per step 301, a signal strength of a mobile device 111 associated with a user relative to a wireless access point 101 located within a premises 113. In another step 303, the module 103 correlates the signal strength to a reference location within the premises based on predetermined wireless fingerprint information associated with the mobile device 111 for the premises. As noted previously, the wireless fingerprint information references different signal strengths of the mobile device 111 at respective different locations of the premises relative to the primary wireless access point 101 and the other wireless access points 109.

By way of this approach, a single mobile device 111 may be associated with different sets of wireless fingerprint information, i.e., corresponding to different premisess. For example, wireless fingerprint information corresponding to a user's personal residence may be stored to the wireless fingerprint information database via a first file name. In addition, wireless fingerprint information corresponding to the same user's workplace may be stored to the wireless fingerprint information database via a second file name. The directional sound module 103 distinguishes between the files, for location determination purposes, based on identification data for a wireless access point at the premises in question (e.g., wireless access point configured at home versus at the workplace).

In step 305, the directional sound module 103 determines, based on the reference location, a direction to transmit an ultrasound signal for conveying audible sound to the user. As noted, the audible sound may correspond to audio, video or multimedia content, such as that executed via the primary WAP 101. Per step 307, the module 103 initiates transmission of the ultrasound signal based on the direction. The ultrasound signal, or beam, is transmitted via an ultrasound speaker 104, which transmits the beam along with the audible sound to within a range of the user or a receiver set.

In step 309 or process 308 (FIG. 3B), the directional sound module 103 determines the signal strength of the mobile device 111 relative to another wireless access point 109 located within the premises. Hence, the signal strength is calculated for the mobile device 111 with respect to the primary WAP 101 and various other wireless access points 109a-109d within the premises. As mentioned previously, the greater the number of wireless access points for which to generate the wireless fingerprint information, the more accurate the deterministic results may be. Per step 311, the module 103 identifies, based on the predetermined wireless fingerprint information, a number of the respective different locations of the premises associated with a referenced signal strength that are within a predetermined threshold of the determined signal strength. For the purpose of explanation, the determined signal strength corresponds to that calculated in real-time/currently for the mobile device 111 while the referenced signal strength corresponds to that calculated via the training process.

In step 313, the directional sound module 103 analyzes the number of respective different locations based on a fingerprinting scheme and a filtering scheme to determine the reference location. As noted above, various different wireless fingerprinting schemes may be applied, including k-closest neighbor fingerprinting or probabilistic estimation. Any wireless fingerprinting approach that is based on signal strength data may be employed. Similarly, various different data filtering and error correction algorithms and models may be employed for refining the location approximation result. This includes, for example, Kalman filtering or particle filtering.

In step 315 of process 314 (FIG. 3C), the directional sound module 103 determines an updated location of the user within the premises 113. In another step 317, the module 103 determines, based on the updated location, an updated direction for transmission of the ultrasound signal. Per step 319, the directional sound module 103 initiates transmission of the ultrasound signal based on the updated direction. As noted previously, the module 103 may generate a signal for invoking transmission of the ultrasound signal via the primary WAP 101 and the speaker system 104. The updated location is based on an updated signal strength of the mobile device 111 relative to the primary wireless access point 101 and the other wireless access points 109. This updated signal strength data is the resulting of movement of the user of the mobile device 111 about the premises 113.

In step 321 of process 320 (FIG. 3D), the directional sound module 103 gathers, as predetermined wireless fingerprint information, the different signal strengths of the mobile device 111 at respective different locations of the premises 113 relative to the wireless access point 101 and the other wireless access points 109. Per step 323, the module 103 stores the different signal strengths of the mobile device at respective different locations of the premises relative to the wireless access point and the other wireless access point in association with profile information for the mobile device and the user. The profile information may include mobile device identifier data, network service provider data, network identification information and the like. It is noted that the predetermined wireless fingerprint information is generated during the training procedure of the mobile device for the premises 113. The wireless fingerprint information enables the mobile device 111 and/or user to be readily characterized and subsequently configured to an audio system of a given premises for supporting directional sound capabilities.

In certain embodiments, the directional sound module 103 may be incorporated for direct use within a primary wireless access point, such as a stereo system or entertainment console. Alternatively, the directional sound module may be connected to an existing stereo system, entertainment console, media player or the like for incorporating the above described capabilities as outlined per the above described procedures. For either implementation, the primary wireless access point is able to act as a primary terminal/access point for collecting signal strength data from other wireless devices within a premises for transmitting targeted audio content.

FIGS. 4A-4D are diagrams of a user of a mobile device receiving audio content from various locations within a premises, according to various embodiments. For the purpose of illustration, the diagrams are described with respect to an exemplary use case of a user employing the directional sound module 103 in connection with a home entertainment system at their home. By way of example, the directional sound module 103 is implemented as a peripheral component 409, which is connected to a component of the home entertainment system via any known connectivity means. Also, for this example, the training procedure for the mobile device 401 of the user is already complete—i.e., predetermined wireless fingerprint information has already been established for the device 401 at the premises.

In FIGS. 4A and 4B, a user 402 of a trained mobile device 401 enters a living room area of the premises. Other users (e.g., the user's roommates 415 and 417) are present in the room and engaged in a conversation. Also within the living room is the home entertainment system, which features various components including a television, a radio receiver 413 and an ultrasound speaker 411. The directional sound module 409, as configured to the receiver 413, interacts with the mobile device 401 of the user 402 via an application.

The application renders various selection options, data views, etc., to the user via a graphical user interface of the device 401. By way of example, the directional sound module 409 causes a notification message 405 to be presented to the user interface 403 of the mobile device 401 for indicating the device 401 is recognized, i.e., via the predetermined wireless fingerprint information. In addition, the current signal strength 410a of the mobile device 401 relative to the radio receiver 413 acting as the primary WAP is shown. Of note, the signal strength 410a may be determined at the device 401 via one or more sensors and subsequently shared with the directional sound module 103. In addition, the primary WAP collects and presents signal strength data 410b associated with other wireless access points in the premises.

Under this scenario, the signal strength 410a between the mobile device 401 and the primary WAP (e.g., 413) is greater than signal strength 410b for a different wireless access point. It is noted, therefore, that signal strengths 410a and 410b are presented to indicate the connectivity level between the device 401 and respective wireless access points for the user's current location within the premises. As the user moves about the premises, the signal strength value is refreshed and presented accordingly with respect to the updated location of the user. For this use case, the application is operating in a Automatic detection mode by way of a AUTO link 407 (e.g., this may also be a default mode). By way of this mode of operation, the mobile device 401 automatically engages the various wireless access points per execution of the directional sound module 409.

The collected signal strengths 410a and 410b are then processed by the directional sound module 403. By way of example, the directional sound module 409 analyzes the signal strengths for the different wireless access points to determine a correlation of the signal strengths with a specific location of the user. This may include, for example, analysis of the predetermined fingerprint information to determine a number k referenced positions within the wireless fingerprint information of the device 401 that best match the observed set of signal strengths 410a and 410b. The directional sound module 409 then calculates the coordinates of the mobile device 401 by applying various wireless fingerprinting techniques, models and error correction filters.

As a result of this processing, the directional sound module 409 produces a location result and orders the ultrasound speaker 411 to send a beam B of ultrasound in the direction of the mobile device of the user 402. For the purpose of illustration, the beam is represented as directional vector that points towards the location of the user 402 as determined; hence, the general direction of the mobile device 401 within the living room. It is noted that for all wave-producing sources, the directivity of the source at maximum corresponds to the size of the source compared to the wavelengths generated by the source (e.g., ultrasound speaker 411). The larger the source is compared to the wavelength of the sound waves, the more directional the resulting beam B. Ultrasound has much shorter wave length than traditional waves. Thus, a combination of a larger physical speaker and ultrasound speaker/transmitter with shorter wavelength can be used to generate the directional sound beam B. The resulting directivity of the ultrasound speaker 411 is higher than physically possible with a traditional loudspeaker system.

As such, beam B is transmitted at a specified ultrasonic frequency so that the ultrasound beam precisely hits the target location of the mobile device 401 and decays into an audible sound wave 419 detectable by the user 402. It is noted, in this example, that the user 402 is able to perceive the audible sound wave 419 while the other people 415 and 417 in the same room are isolated from the sound. Also, of note, in this example the user 402 is able to receive the transmission without a dedicated headset or a signal demodulation device. Alternatively, the user may wear such a device for further isolating the audible sound for their listening enjoyment.

In FIG. 4C, the user 402 exits the living room area via a door 433 and enters an adjacent room. The adjacent room includes a computer system 431 that serves as another wireless access point within the premises. In response to the movement of the user 402, an updated signal strength of the mobile device relative to the primary WAP and the other wireless access point 431 for the user's 402 new location is determined. As before, this information is then used via signal based wireless fingerprinting processing to determine a relative location of the mobile device; thus corresponding to the new location of the user 402. The directional sound module 409 then causes transmission of the audible sound, via the ultrasound speaker system 411, in the direction of the user within the adjacent room.

In FIG. 4D, the application for interacting with the directional sound module 409 is shown operating in a manual mode of operation. This is indicated by way of active highlighting of a MANUAL link 427 via the user interface 403. Under this mode of operation, the user is able to specify a location within the premises to direct the sound. This is in contrast to the above described procedure, wherein the directivity of the sound is determined automatically by the directional sound module 409 based on real-time detected signal strength information for the device 401. By way of example, the user 402 is presented with a visual depiction of a floor plan 435 of the premises. The user can then pinpoint a location/spot 437 on the floor plan 435 to direct sound to via the primary WAP. The location/spot 437 may be specified by way of touch screen selection or other selection means. The user can select a new location/spot as they move about the premises.

The exemplary techniques and systems presented herein enable audio content to be directed to a select user from any location within a premises. One advantage of the exemplary techniques and systems presented herein is the ability of an ultrasonic speaker system to be directed and guided automatically and continually (as a mobile device user navigates) based on a geolocation of the user within the premises. Also, the directional sound module 403 may be used in connection with various known audio systems and the like. For example, the application for interacting with the directional sound module may be used in connection with a mobile remote application operable by the device. As such, directional sound management may be offered in conjunction with various controls for browsing television listings and managing digital video recordings.

The processes described herein for enabling audio content to be directed to a select user from any location within a premises may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

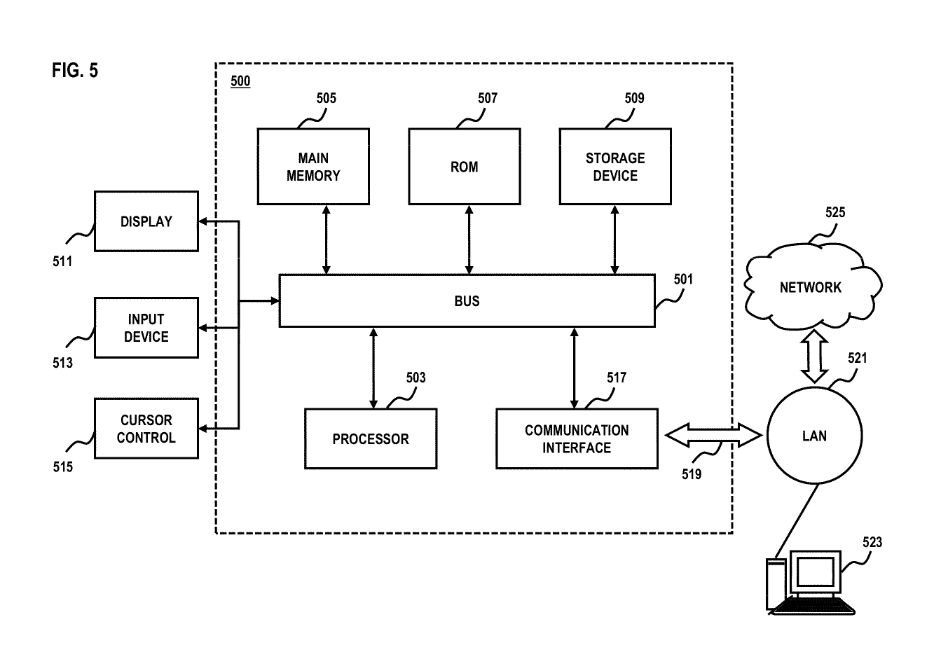

FIG. 5 is a diagram of a computer system that can be used to implement various exemplary embodiments. The computer system 500 includes a bus 501 or other communication mechanism for communicating information and one or more processors (of which one is shown) 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for adjusting cursor movement on the display 511.

According to an embodiment of the invention, the processes described herein are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the invention. Thus, embodiments of the invention are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIG. 5, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and the network 525 both use electrical, electromagnetic, or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the Internet example, a server (not shown) might transmit requested code belonging to an application program for implementing an embodiment of the invention through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 6 illustrates a chip set or chip 600 upon which an embodiment of the invention may be implemented. Chip set 600 is programmed to enable audio content to be directed to a select user from any location within a premises as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of enabling audio content to be directed to a select user from any location within a premises.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to enable audio content to be directed to a select user from any location within a premises. The memory 605 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method of claim 1, further comprising:
determining a signal strength of a mobile device associated with a user relative to a wireless access point located within a premises;
correlating the signal strength to a reference location within the premises based on predetermined wireless fingerprint information associated with the mobile device for the premises, the wireless fingerprint information referencing different signal strengths of the mobile device at respective different locations of the premises relative to the wireless access point and other wireless access points; and
determining, based on the reference location, a direction to transmit an ultrasound signal for conveying audible sound to the user.

2. A method of claim 1, further comprising:
initiating transmission of the ultrasound signal based on the direction,
wherein the signal is transmitted by an ultrasound transmitter located within the premises.

3. A method of claim 1, further comprising:
determining the signal strength of the mobile device relative to another wireless access point located within the premises,
wherein the other wireless access point is at a different location within the premises than the (primary) wireless access point.

4. A method of claim 1, further comprising:
determining an updated location of the mobile device within the premises; and
determining, based on the updated location, an updated direction for transmission of the ultrasound signal,
wherein the updated location is based on the determining of a updated signal strength of the mobile device relative to the primary access point and the other wireless access point.

5. A method of claim 1, further comprising:
initiating, via the ultrasound transmitter, transmission of the ultrasound signal based on the updated direction.

6. A method of claim 1, further comprising:
gathering, via a training procedure, the different signal strengths of the mobile device at respective different locations of the premises relative to the wireless access point and the other wireless access point; and
storing the different signal strengths of the mobile device at respective different locations of the premises relative to the wireless access point and the other wireless access point in association with profile information for the mobile device and the user,
wherein the predetermined wireless fingerprint information is generated during the training procedure of the mobile device for the premises.

7. A method of claim 1, further comprising:
identifying, based on the predetermined wireless fingerprint information, a number of the respective different locations of the premises associated with a referenced signal strength are within a predetermined threshold of the determined signal strength of the mobile device; and
analyzing the number of respective different locations based on a wireless fingerprinting scheme and a filtering scheme to determine the reference location.

8. A method of claim 1, wherein the audible sound is associated with video content, audio content or multimedia content.

9. A method of claim 8, wherein the content is played by a stereo system, a set-top box, a computer system, a television or a media player.

10. A method of claim 1, wherein the reference location for directing of the audio signal is within a predetermined range of the user or a receiver set of the user.

11. An apparatus comprising:
at least one processor; and
at least one memory including computer program code for one or more programs,
the at least one memory and the computer program code configured to, with the at least one processor, cause the apparatus to perform at least the following,
determining a signal strength of a mobile device associated with a user relative to a wireless access point located within a premises;
correlating the signal strength to a reference location within the premises based on predetermined wireless fingerprint information associated with the mobile device for the premises, the wireless fingerprint information referencing different signal strengths of the mobile device at respective different locations of the premises relative to the wireless access point and other wireless access points; and
determining, based on the reference location, a direction to transmit an ultrasound signal for conveying audible sound to the user

12. An apparatus of claim 11, further comprising:
initiating transmission of the ultrasound signal based on the direction,
wherein the signal is transmitted by an ultrasound transmitter located within the premises.

13. An apparatus of claim 11, further comprising:
determining the signal strength of the mobile device relative to another wireless access point located within the premises,
wherein the other wireless access point is at a different location within the premises than the wireless access point.

14. An apparatus of claim 11, further comprising:
determining an updated location of the mobile device within the premises; and
determining, based on the updated location, an updated direction for transmission of the ultrasound signal,
wherein the updated location is based on the determining of a updated signal strength of the mobile device relative to the primary access point and the other wireless access point.

15. An apparatus of claim 11, further comprising:
initiating, via the ultrasound transmitter, transmission of the ultrasound signal based on the updated direction.

16. An apparatus of claim 11, further comprising:
gathering, via a training procedure, the different signal strengths of the mobile device at respective different locations of the premises relative to the wireless access point and the other wireless access point; and
storing the different signal strengths of the mobile device at respective different locations of the premises relative to the wireless access point and the other wireless access point in association with profile information for the mobile device and the user,
wherein the predetermined wireless fingerprint information is generated during the training procedure of the mobile device for the premises.

17. An apparatus of claim 11, further comprising:
identifying, based on the predetermined wireless fingerprint information, a number of the respective different locations of the premises associated with a referenced signal strength are within a predetermined threshold of the determined signal strength of the mobile device; and
analyzing the number of respective different locations based on a wireless fingerprinting scheme and a filtering scheme to determine the reference location.

18. An apparatus of claim 11, wherein the audible sound is associated with video content, audio content or multimedia content.

19. An apparatus of 18, wherein the content is played by a stereo system, a set-top box, a computer system, a television or a media player.

20. An apparatus of claim 11, wherein the reference location for directing of the audio signal is within a predetermined range of the user or a receiver set of the user.
